(19) United States
(12) Patent Application Publication
(10) Pub. No.: US 2013/0107163 A1
(43) Pub. Date: May 2, 2013

(54) LIQUID CRYSTAL DISPLAY DEVICE

(71) Applicant: Japan Display East Inc., Mobara-shi (JP)

(72) Inventor: Eiji OOHIRA, Mobara (JP)

(73) Assignee: Japan Display East Inc., Mobara-shi (JP)

(21) Appl. No.: 13/664,543

(22) Filed: Oct. 31, 2012

(30) Foreign Application Priority Data
Oct. 31, 2011 (JP) 2011-238331

(51) Int. Cl. G02F 1/13357

(52) U.S. Cl. 349/60

(57) ABSTRACT

Light emitting components are mounted on the component mounting portion and arranged in a line along the length of the component mounting portion. Wirings are led out from the extended portion to the component mounting portion and include a first group of wirings which extend in a first direction along the length of the component mounting portion, and a second group of wirings which extend in a second direction that is opposite to the first direction. The light emitting components include a first group of light emitting components arranged on the first direction side of the component mounting portion, and a second group of light emitting components arranged on the second direction side of the component mounting portion, the number of the first group of light emitting components and the number of the second group of light emitting components being the same.

### CROSS-REFERENCE TO RELATED APPLICATION

The present application claims priority from Japanese application JP 2011-238331 filed on Oct. 31, 2011, the content of which is hereby incorporated by reference into this application.

### BACKGROUND OF THE INVENTION

1. Field of the Invention

The present invention relates to a liquid crystal display.

2. Description of the Related Art

A liquid crystal display with a backlight unit includes a liquid crystal display panel and light emitting components. It is known that a flexible wiring board is used for each of electrical connection between the liquid crystal display panel and the outside and electrical connection between the light emitting components and the outside. Further, it is also known to commonalize the flexible wiring board for electrical connection between the liquid crystal display panel and the outside and the flexible wiring board for electrical connection between the light emitting components and the outside (Japanese Patent Application Laid-open No. 2010-62016).

Japanese Patent Application Laid-open No. 2010-62016 discloses that wiring is carried out only on one side of the flexible wiring board, which is effective in reducing the thickness of the flexible wiring board. However, there is a problem that the width of a portion of the flexible wiring board on which the light emitting components are mounted increases. Even when multilayer wiring is used, if the number of the light emitting components increases, the problem that the width of the flexible wiring board increases is not solved.

### SUMMARY OF THE INVENTION

It is an object of the present invention to reduce a width of a portion of a flexible wiring board on which light emitting components are mounted.

(1) According to an exemplary embodiment of the present invention, there is provided a liquid crystal display including: a liquid crystal display panel; a backlight unit including a plurality of light emitting components and a light guide plate; and a flexible wiring board which is attached to the liquid crystal display panel and on which the plurality of light emitting components are mounted, in which: the flexible wiring board includes a substrate and a plurality of wirings formed side by side on one surface of the substrate; the substrate includes a main body portion which has an end portion attached to the liquid crystal display panel and extends away from the liquid crystal display panel, an extended portion which extends from the main body portion in a direction opposite to the end portion, a connector portion which is disposed beside and spaced from the extended portion and extends from the main body portion in the direction opposite to the end portion, and a component mounting portion connected to the extended portion; the extended portion is connected to the component mounting portion via a bent portion; the component mounting portion has a length extending in both directions of right and left along a width direction of the liquid crystal display panel from a portion at which the component mounting portion is connected to the extended portion, and a width orthogonal to the length; the plurality of light emitting components are mounted on the component mounting portion and are arranged in a line in a direction along the length of the component mounting portion; the plurality of wirings are formed so as to pass through the extended portion and the component mounting portion to be electrically connected to the plurality of light emitting components, respectively; the plurality of wirings are led out from the extended portion to the component mounting portion and include a first group of wirings extending in a first direction along the length of the component mounting portion and a second group of wirings extending in a second direction that is opposite to the first direction; the plurality of light emitting components include a first group of light emitting components arranged on the first direction side of the component mounting portion, and a second group of light emitting components arranged on the second direction side of the component mounting portion, a number of the first group of light emitting components and a number of the second group of light emitting components being the same; the first group of wirings are electrically connected to the first group of light emitting components, respectively; and the second group of wirings are electrically connected to the second group of light emitting components, respectively. According to the present invention, the number of the first group of light emitting components arranged on the first direction side and the number of the second group of light emitting components arranged on the second direction side are the same, and thus, wiring is not one-sided any one of on the first direction side and on the second direction side. Therefore, the width of a portion of the flexible wiring board on which the light emitting components are mounted can be reduced.

(2) In the liquid crystal display as described in the above-mentioned item (1): the first group of wirings may be formed in a region of the component mounting portion on the extended portion side with respect to the plurality of light emitting components so that the first group of adjacent wirings are arranged side by side in the width direction of the component mounting portion and each of the first group of wirings extends in the length direction of the component mounting portion; the second group of wirings may be formed in a region of the component mounting portion on the extended portion side with respect to the plurality of light emitting components so that the second group of adjacent wirings are arranged side by side in the width direction of the component mounting portion and each of the second group of wirings extends in the length direction of the component mounting portion; and the component mounting portion may include a first maximum side-by-side region in which portions of all the first group of wirings extending in the length direction of the component mounting portion are arranged side by side in the width direction of the component mounting portion, and a second maximum side-by-side region in which portions of all the second group of wirings extending in the length direction of the component mounting portion are arranged side by side in the width direction of the component mounting portion.

(3) In the liquid crystal display as described in the above-mentioned item (2), the plurality of light emitting components may further include a third light emitting component disposed between the first group of light emitting components and the second group of light emitting components, and the plurality of wirings may further include a third group of wirings which are led out from the extended portion to the component mounting portion to be electrically connected to the third light emitting component.

(4) In the liquid crystal display as described in any one of the above-mentioned items (1) to (3), the extended portion may be formed into a shape of a crank.

(5) In the liquid crystal display as described in any one of the above-mentioned items (1) to (4), the plurality of wirings may pass, in the main body portion, through a region which is offset in a direction in which the extended portion is off-center to any one of the right and the left with respect to the main body portion.

(6) In the liquid crystal display as described in the above-mentioned item (2) or (3): the flexible wiring board may be a single-layer wiring board; each of the plurality of light emitting components may include an anode electrode and a cathode electrode; and a number of the plurality of wirings may be twice as large as a number of the plurality of light emitting components.

(7) In the liquid crystal display as described in the above-mentioned item (2) or (3): each of the plurality of light emitting components may include a same-potential electrode connected to the same potential; the flexible wiring board maybe a multilayer wiring substrate; and the plurality of wirings may be formed so as to three-dimensionally intersect one another and may include a wiring group which branch in the component mounting portion from one of the plurality of wirings passing through the extended portion, the wiring group being connected to the same-potential electrodes of the plurality of light emitting components.

(8) In the liquid crystal display as described in the above-mentioned item (7): the each of the plurality of light emitting components may include an anode electrode and a cathode electrode;

one of the anode electrode and the cathode electrode may be the same-potential electrode; and a number of wirings arranged side by side in the width direction of the component mounting portion in the first maximum side-by-side region may be n1+1, and a number of wirings arranged side by side in the width direction of the component mounting portion in the second maximum side-by-side region may be n2+1, where n1 represents the number of the first group of light emitting components and n2 represents the number of the second group of light emitting components.

(9) In the liquid crystal display as described in any one of the above-mentioned items (1) to (8), the portion at which the component mounting portion is connected to the extended portion maybe located between a line in the width direction of the component mounting portion passing through a center of a light emitting component along the length of the component mounting portion, the light emitting component being closest among the first group of light emitting components to the second group of light emitting components, and a line in the width direction of the component mounting portion passing through a center of a light emitting component along the length of the component mounting portion, the light emitting component being closest among the second group of light emitting components to the first group of light emitting components.

(10) In the liquid crystal display as described in the above-mentioned item (3), the portion at which the component mounting portion is connected to the extended portion may be located between a line in the width direction of the component mounting portion passing through a midpoint between a light emitting component which is closest among the first group of light emitting components to the third light emitting component and the third light emitting component, and a line in the width direction of the component mounting portion passing through a midpoint between a light emitting component which is closest among the second group of light emitting components to the third light emitting component and the third light emitting component.

### BRIEF DESCRIPTION OF THE DRAWINGS

In the accompanying drawings:

FIG. 1 is a sectional view illustrating a liquid crystal display according to a first embodiment of the present invention;

FIG. 2 is a bottom view of a liquid crystal display panel in a state in which a flexible wiring board is developed;

FIG. 3 is a detail view of a component mounting portion and a bent portion of the flexible wiring board;

FIG. 4 is a partial view of a flexible wiring board used in a liquid crystal display according to a second embodiment of the present invention;

FIG. 5 is a partial view of a flexible wiring board used in a liquid crystal display according to a third embodiment of the present invention; and

FIG. 6 is a partial view of a flexible wiring board used in a liquid crystal display according to a fourth embodiment of the present invention.

### DETAILED DESCRIPTION OF THE INVENTION

Embodiments of the present invention are described in the following with reference to the attached drawings.

### First Embodiment]

FIG. 1 is a sectional view illustrating a liquid crystal display according to a first embodiment of the present invention. The liquid crystal display includes a liquid crystal display panel 10. The liquid crystal display panel 10 includes a pair of substrates 12 and 14 (both of which are, for example, glass substrates), and liquid crystal (not shown) interposed between the pair of substrates. One substrate 12 is a thin film transistor (TFT) substrate (or an array substrate) including thin film transistors, pixel electrodes, and wiring, while the other substrate 14 is a color filter substrate. The liquid crystal display panel 10 may be driven by any one of an in plane switching (IPS) system, a twisted nematic (TN) system, a vertical alignment (VA) system, and the like, and electrodes and wiring according to the system are formed.

The one substrate 12 of the liquid crystal display panel 10 includes a protruding portion 16 which protrudes from the other substrate 14. The liquid crystal display panel 10 (specifically, the protruding portion 16) has an integrated circuit chip 18 mounted thereon for integrating therein a driver circuit for driving the liquid crystal. A polarizing plate 20 is bonded to each of the pair of substrates 12 and 14 of the liquid crystal display panel 10.

The liquid crystal display includes a frame 22 formed of, for example, a resin. The liquid crystal display panel 10 is attached to the frame 22. Specifically, the frame 22 is in the shape of a frame, and the liquid crystal display panel 10 is bonded using light-shielding double-faced tape 24 to one surface of the frame so as to cover space inside the frame. An end portion of the liquid crystal display panel 10 is supported by the frame 22 on a rear surface side.

The liquid crystal display includes a backlight unit 26. The backlight unit 26 includes a light guide plate 28. A front surface of the light guide plate 28 faces the rear surface of the liquid crystal display panel 10. The light guide plate 28 is disposed on the rear surface side of the liquid crystal display panel 10 away from under the end portion of the liquid crystal display panel 10.

An optical sheet group 30 is disposed between the liquid crystal display panel 10 and the light guide plate 28. The optical sheet group 30 includes a diffusion sheet and a prism sheet. Further, a reflective sheet 32 is disposed under the light guide plate 28 (on the side opposite to the optical sheet group 30).

The backlight unit 26 includes a plurality of light emitting components 34. The light emitting components 34 are, for example, light-emitting diodes. The light emitting components 34 are point light sources for introducing light into the light guide plate 28. Light from the point light sources is converted by the light guide plate 28 to a surface light source to be applied to the liquid crystal display panel 10. The light emitting components 34 face an end surface of the light guide plate 28.

The liquid crystal display includes a flexible wiring board 36. In this embodiment, the flexible wiring board 36 is a single-layer wiring board. The flexible wiring board 36 is attached to the liquid crystal display panel 10. As illustrated in FIG. 1, the flexible wiring board 36 is bent so as to go around from a surface on a display side of the liquid crystal display panel 10 to the rear surface thereof.

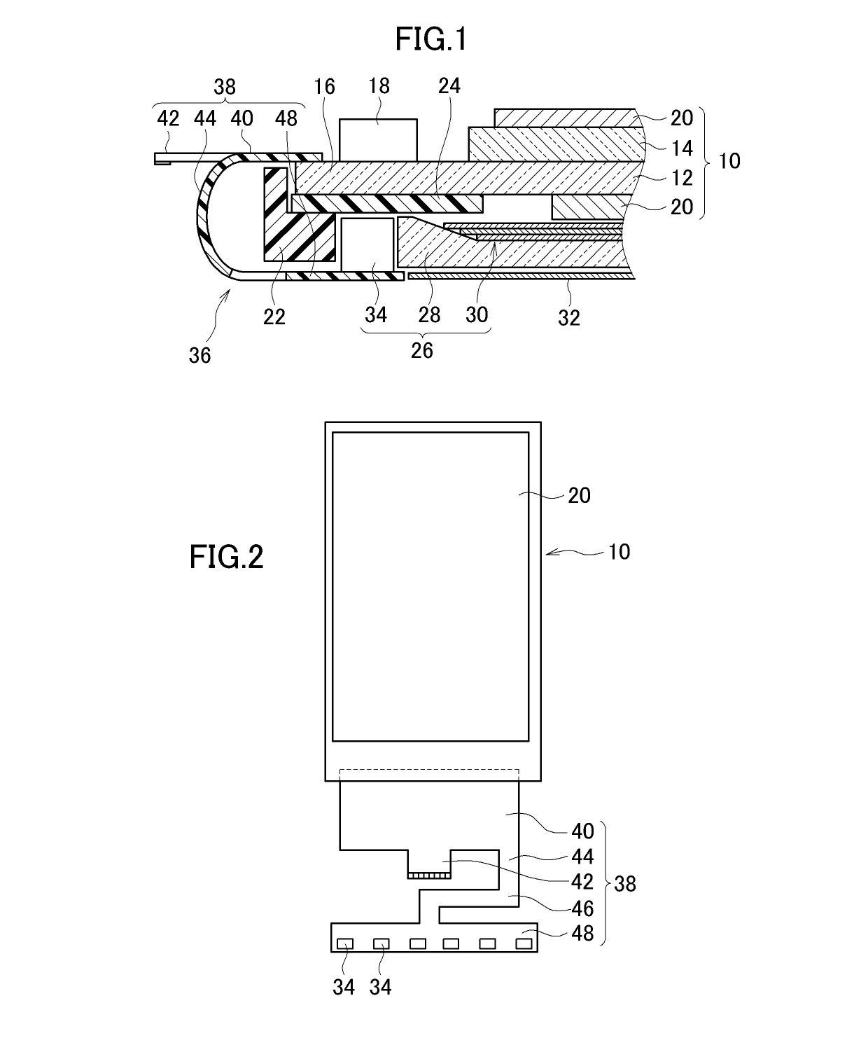

FIG. 2 is a bottom view of the liquid crystal display panel 10 in a state in which the flexible wiring board 36 is developed. The flexible wiring board 36 includes a substrate 38.

The substrate 38 includes a main body portion 40. Electronic components (not shown) are mounted on the main body portion 40. An end portion of the main body portion 40 is attached to the liquid crystal display panel 10 (specifically, the protruding portion 16) to be electrically connected thereto. The main body portion 40 extends away from the liquid crystal display panel 10. The substrate 38 includes a connector portion 42 for electrical connection to the outside. The connector portion 42 extends from the main body portion 40 in a direction opposite to the end portion thereof (away from the liquid crystal display panel 10).

The substrate 38 includes an extended portion 44. The extended portion 44 extends from the main body portion 40 in a direction opposite to the end portion attached to the liquid crystal display panel 10 at a position which is off-center to any one of the right and the left along a width direction of the liquid crystal display panel 10. The extended portion 44 is disposed beside but spaced from the connector portion 42 along the width direction of the liquid crystal display panel 10.

The extended portion 44 includes a bent portion 46. The bent portion 46 is bent in a direction opposite to the direction of the off-center movement to any one of the right and the left of the extended portion 44 with respect to the main body portion 40. The extended portion 44 as a whole including the bent portion 46 is formed into the shape of a crank.

The substrate 38 includes a component mounting portion 48. The component mounting portion 48 is located in a direction opposite to the end portion attached to the liquid crystal display panel 10 so as to be spaced from the connector portion 42. The component mounting portion 48 extends in the width direction of the liquid crystal display panel 10. The length of the component mounting portion 48 is a lateral length along the width direction of the liquid crystal display panel 10. The width of the component mounting portion 48 is a width in a direction orthogonal to the length of the component mounting portion 48. The component mounting portion 48 is connected to the extended portion 44. A portion at which the extended portion 44 is connected to the main body portion 40 and a portion at which the extended portion 44 is connected to the component mounting portion 48 are not aligned.

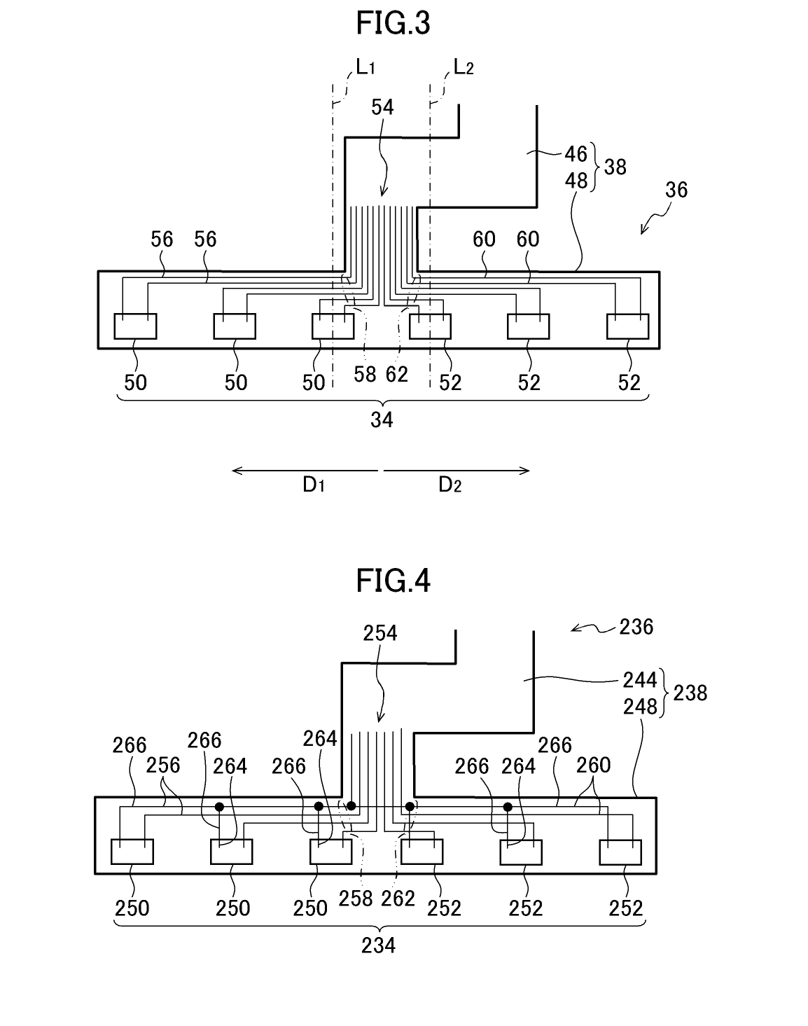

FIG. 3 is a detail view of the component mounting portion 48 and the bent portion 46 of the flexible wiring board 36. The flexible wiring board 36 (specifically, the component mounting portion 48) has the above-mentioned plurality of light emitting components 34 mounted thereon. As illustrated in FIG. 1, a surface of the component mounting portion 48 on which the light emitting components 34 are mounted is disposed so as to face the liquid crystal display panel 10. As illustrated in FIG. 3, the plurality of light emitting components 34 are arranged in a line in a direction along the length of the component mounting portion 48. The length of the component mounting portion 48 is the length extending from the portion at which the component mounting portion 48 is connected to the extended portion 44 to both the right and the left along the width direction of the liquid crystal display panel 10. Each of the plurality of light emitting components 34 includes an anode electrode and a cathode electrode.

The plurality of light emitting components 34 include a first group of light emitting components 50 arranged on a first direction D1 side of the component mounting portion 48. The plurality of light emitting components 34 include a second group of light emitting components 52 arranged on a second direction D2 side of the component mounting portion 48. The number of the first group of light emitting components 50 and the number of the second group of light emitting components 52 are the same.

The portion at which the component mounting portion 48 is connected to the extended portion 44 is located between a line L1 and a line L2. The line L1 is a straight line in a width direction passing through a center of a light emitting component along the length of the component mounting portion 48, the light emitting component being the closest among the first group of light emitting components 50 to the second group of light emitting components 52. The line L2 is a straight line in the width direction passing through a center of a light emitting component along the length of the component mounting portion 48, the light emitting component being the closest among the second group of light emitting components 52 to the first group of light emitting components 50.

A plurality of wirings 54 are formed so that the wirings are arranged side by side on one surface of the substrate 38. The number of the plurality of wirings 54 is twice as large as the number of the plurality of light emitting components 34. In the main body portion 40 illustrated in FIG. 2, the plurality of wirings 54 pass through a region which is offset in a direction in which the extended portion 44 is off-center to any one of the right and the left with respect to the main body portion 40 (right side in FIG. 2). The wirings 54 are formed so as to pass through the extended portion 44 and the component mounting portion 48. The wirings 54 are led out from the extended portion 44 to the component mounting portion 48. Each of the wirings 54 is electrically connected to any one of the light emitting components 34.

The plurality of wirings 54 include a first group of wirings 56 extending in the first direction D1 along the length of the component mounting portion 48. The first group of wirings 56 are electrically connected to the first group of light emitting components 50. In a region of the component mounting portion 48 on the extended portion 44 side with respect to the plurality of light emitting components 34, the first group of wirings 56 are arranged so that the adjacent wirings are arranged side by side in the width direction of the component mounting portion 48. Further, in the region of the component mounting portion 48 on the extended portion 44 side with respect to the plurality of light emitting components 34, each wiring of the first group of wirings 56 extends in a length direction of the component mounting portion 48. In a region which is a part of the component mounting portion 48 (first maximum side-by-side region 58), a part of all the first group of wirings 56 (portions extending in the length direction of the component mounting portion 48) are arranged side by side in the width direction of the component mounting portion 48.

The plurality of wirings 54 include a second group of wirings 60 extending in the second direction D2 which is opposite to the first direction D1 from the extended portion 44. The second group of wirings 60 are electrically connected to the second group of light emitting components 52. In the region of the component mounting portion 48 on the extended portion 44 side with respect to the plurality of light emitting components 34, the second group of wirings 60 are arranged so that the adjacent wirings are arranged side by side in the width direction of the component mounting portion 48. Further, in the region of the component mounting portion 48 on the extended portion 44 side with respect to the plurality of light emitting components 34, each wiring of the second group of wirings 60 is formed so as to extend in the length direction of the component mounting portion 48. In a region which is a part of the component mounting portion 48 (second maximum side-by-side region 62), a part of all the second group of wirings 60 (portions extending in the length direction of the component mounting portion 48) are arranged side by side in the width direction of the component mounting portion 48.

According to this embodiment, the number of the first group of light emitting components 50 arranged on the first direction D1 side and the number of the second group of light emitting components 52 arranged on the second direction D2 side are the same, and thus, the number of the wirings 54 is balanced between the first direction D1 and the second direction D2. Therefore, the width of the component mounting portion 48 on which the light emitting components 34 of the flexible wiring board 36 are mounted may be reduced.

### Second Embodiment

FIG. 4 is a partial view of a flexible wiring board used in a liquid crystal display according to a second embodiment of the present invention. A flexible wiring board 236 is a multilayer wiring board. A plurality of wirings 254 are formed so that the wirings three-dimensionally intersect one another. In FIG. 4, the wirings are illustrated in a wiring diagram, and the wirings 254 three-dimensionally intersect one another at positions of intersections without electrical connection. Specifically, three-dimensional electrical connection is made via through holes or the like (not shown). At positions of electrical connections between the wirings 254, the wirings 254 are formed only on one surface of a substrate 238.

Each of a plurality of light emitting components 234 includes an anode electrode and a cathode electrode. Each of the plurality of light emitting components 234 includes a same-potential electrode 264 connected to the same potential. One of the anode electrode and the cathode electrode (for example, anode electrode) is the same-potential electrode 264.

The plurality of wirings 254 include a wiring group 266 which branch in a component mounting portion 248 from one of the wirings passing through an extended portion 244. The branching is made only on one surface of the substrate 238. The branched wiring group 266 are connected to the same-potential electrodes 264 of the plurality of light emitting components 234, respectively.

A first group of light emitting components 250 the number of which is n1 and a second group of light emitting components 252 the number of which is n2 are mounted on the component mounting portion 248. The number of a first group of wirings 256 arranged side by side in a width direction of the component mounting portion 248 in a first maximum side-by-side region 258 is n1+1. The number of a second group of wirings 260 arranged side by side in the width direction of the component mounting portion 248 in a second maximum side-by-side region 262 is n2+1. Description made in the above-mentioned first embodiment applies to other details.

### Third Embodiment

FIG. 5 is a partial view of a flexible wiring board used in a liquid crystal display according to a third embodiment of the present invention.

A plurality of light emitting components 334 include a third light emitting component 366 disposed between a first group of light emitting components 350 and a second group of light emitting components 352. It follows that, while, in the above-mentioned first embodiment and the second embodiment, the number of the plurality of light emitting components 34 is an even number, the number of the plurality of light emitting components 334 in this embodiment is an odd number. A plurality of wirings 354 include a third group of wirings 368 which are led out from an extended portion 344 to a component mounting portion 348 to be electrically connected to the third light emitting component 366. Description made in the above-mentioned first embodiment applies to other details.

A portion at which the component mounting portion 348 is connected to the extended portion 344 is located between a line L31 and a line L32. The line L31 extends in a width direction of the component mounting portion 348 so as to pass through the midpoint between a light emitting component which is the closest among the first group of light emitting components 350 to the third light emitting component 366 and the third light emitting component 366. The line L32 extends in the width direction of the component mounting portion 348 so as to pass through the midpoint between a light emitting component which is the closest among the second group of light emitting components 352 to the third light emitting component 366 and the third light emitting component 366.

According to this embodiment, also, the number of the first group of light emitting components 350 arranged on the first direction D1 side and the number of the second group of light emitting components 352 arranged on the second direction D2 side are the same, and thus, the number of the wirings 354 is balanced between the first direction D1 and the second direction D2. Therefore, the width of the component mounting portion 348 on which the light emitting components 334 of a flexible wiring board 336 are mounted may be reduced.

### Fourth Embodiment

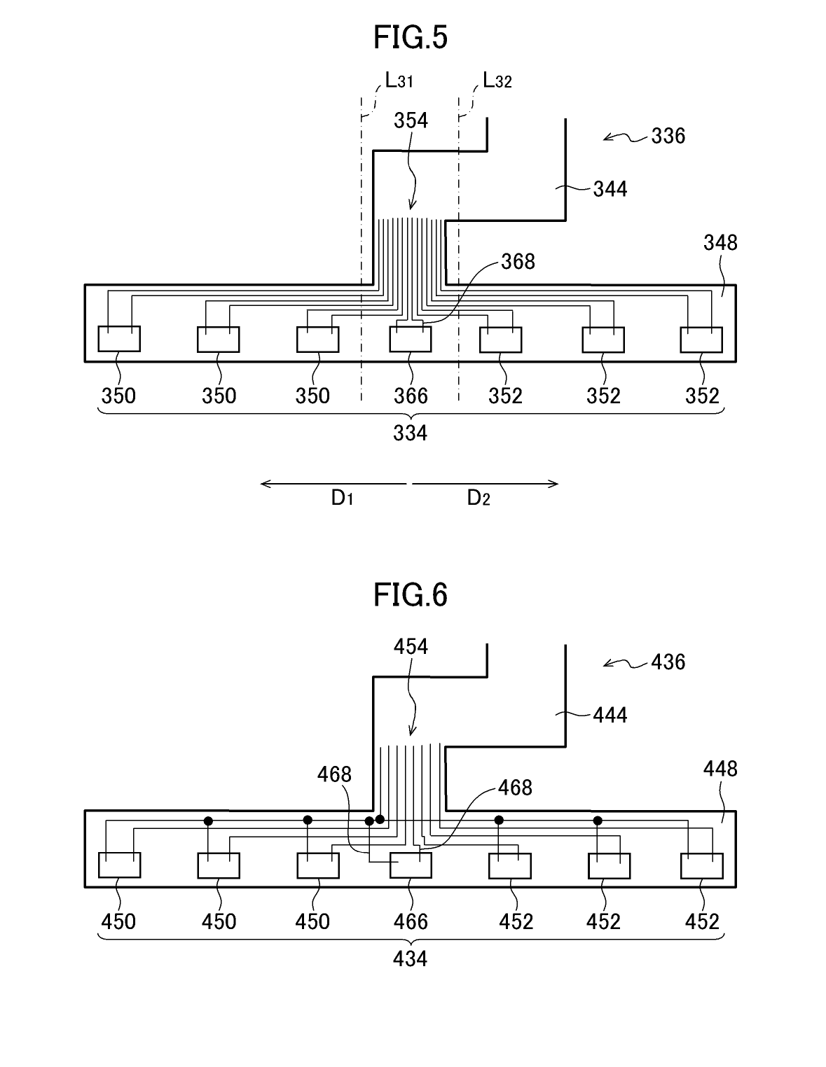

FIG. 6 is a partial view of a flexible wiring board used in a liquid crystal display according to a fourth embodiment of the present invention.

A plurality of light emitting components 434 include a third light emitting component 466 disposed between a first group of light emitting components 450 and a second group of light emitting components 452. A plurality of wirings 454 include a third group of wirings 468 which are led out from an extended portion 444 to a component mounting portion 448 to be electrically connected to the third light emitting component 466.

In this embodiment, a flexible wiring board 436 is a multilayer wiring board, and description made in the second embodiment applies to details thereof. In this embodiment, the number of the plurality of light emitting components 434 is an odd number, and description made in the third embodiment applies to details thereof. Description made in the above-mentioned first embodiment applies to other details.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display, comprising:
a liquid crystal display panel;
a backlight unit including a plurality of light emitting components and a light guide plate; and
a flexible wiring board which is attached to the liquid crystal display panel and on which the plurality of light emitting components are mounted, wherein:
the flexible wiring board includes a substrate and a plurality of wirings formed side by side on one surface of the substrate;
the substrate includes a main body portion which has an end portion attached to the liquid crystal display panel and extends away from the liquid crystal display panel, an extended portion which extends from the main body portion in a direction opposite to the end portion, a connector portion which is disposed beside and spaced from the extended portion and extends from the main body portion in the direction opposite to the end portion, and a component mounting portion connected to the extended portion;
the extended portion is connected to the component mounting portion via a bent portion;
the component mounting portion has a length extending in both directions of right and left along a width direction of the liquid crystal display panel from a portion at which the component mounting portion is connected to the extended portion, and a width orthogonal to the length;
the plurality of light emitting components are mounted on the component mounting portion and are arranged in a line in a direction along the length of the component mounting portion;
the plurality of wirings are formed so as to pass through the extended portion and the component mounting portion to be electrically connected to the plurality of light emitting components, respectively;
the plurality of wirings are led out from the extended portion to the component mounting portion and include a first group of wirings extending in a first direction along the length of the component mounting portion and a second group of wirings extending in a second direction that is opposite to the first direction;
the plurality of light emitting components include a first group of light emitting components arranged on the first direction side of the component mounting portion, and a second group of light emitting components arranged on the second direction side of the component mounting portion, a number of the first group of light emitting components and a number of the second group of light emitting components being the same;
the first group of wirings are electrically connected to the first group of light emitting components, respectively; and
the second group of wirings are electrically connected to the second group of light emitting components, respectively.

2. The liquid crystal display according to claim 1, wherein:
the first group of wirings are formed in a region of the component mounting portion on the extended portion side with respect to the plurality of light emitting components so that the first group of adjacent wirings are arranged side by side in the width direction of the component mounting portion and each of the first group of wirings extends in the length direction of the component mounting portion;
the second group of wirings are formed in a region of the component mounting portion on the extended portion side with respect to the plurality of light emitting components so that the second group of adjacent wirings are arranged side by side in the width direction of the component mounting portion and each of the second group of wirings extends in the length direction of the component mounting portion; and
the component mounting portion includes a first maximum side-by-side region in which portions of all the first group of wirings extending in the length direction of the component mounting portion are arranged side by side in the width direction of the component mounting portion, and a second maximum side-by-side region in which portions of all the second group of wirings extending in the length direction of the component mounting portion are arranged side by side in the width direction of the component mounting portion.

3. The liquid crystal display according to claim 2, wherein:
the plurality of light emitting components further include a third light emitting component disposed between the first group of light emitting components and the second group of light emitting components; and
the plurality of wirings further include a third group of wirings which are led out from the extended portion to the component mounting portion to be electrically connected to the third light emitting component.

4. The liquid crystal display according to claim 1, wherein the extended portion is formed into a shape of a crank.

5. The liquid crystal display according to claim 1, wherein the plurality of wirings pass, in the main body portion, through a region which is offset in a direction in which the extended portion is off-center to any one of the right and the left with respect to the main body portion.

6. The liquid crystal display according to claim 2, wherein:
the flexible wiring board comprises a single-layer wiring board;
each of the plurality of light emitting components includes an anode electrode and a cathode electrode; and
a number of the plurality of wirings is twice as large as a number of the plurality of light emitting components.

7. The liquid crystal display according to claim 2, wherein:
each of the plurality of light emitting components includes a same-potential electrode connected to the same potential;
the flexible wiring board comprises a multilayer wiring board; and
the plurality of wirings are formed so as to three-dimensionally intersect one another and include a wiring group which branch in the component mounting portion from one of the plurality of wirings passing through the extended portion, the wiring group being connected to the same-potential electrodes of the plurality of light emitting components.

8. The liquid crystal display according to claim 7, wherein:
the each of the plurality of light emitting components includes an anode electrode and a cathode electrode;
one of the anode electrode and the cathode electrode comprises the same-potential electrode; and
a number of wirings arranged side by side in the width direction of the component mounting portion in the first maximum side-by-side region is n1+1, and a number of wirings arranged side by side in the width direction of the component mounting portion in the second maximum side-by-side region is n2+1,
where n1 represents the number of the first group of light emitting components and n2 represents the number of the second group of light emitting components.

9. The liquid crystal display according to claim 1, wherein the portion at which the component mounting portion is connected to the extended portion is located between a line in the width direction of the component mounting portion passing through a center of a light emitting component along the length of the component mounting portion, the light emitting component being closest among the first group of light emitting components to the second group of light emitting components, and a line in the width direction of the component mounting portion passing through a center of a light emitting component along the length of the component mounting portion, the light emitting component being closest among the second group of light emitting components to the first group of light emitting components.

10. The liquid crystal display according to claim 3, wherein the portion at which the component mounting portion is connected to the extended portion is located between a line in the width direction of the component mounting portion passing through a midpoint between a light emitting component which is closest among the first group of light emitting components to the third light emitting component and the third light emitting component, and a line in the width direction of the component mounting portion passing through a midpoint between a light emitting component which is closest among the second group of light emitting components to the third light emitting component and the third light emitting component.
